(19) United States
(12) Patent Application Publication
(10) Pub. No.: US 2023/0078864 A1
(43) Pub. Date: Mar. 16, 2023

(54) Direct air displacement pump for liquids with smart controller

(71) Applicant: George Androutsos, Noranda (AU)

(72) Inventor: George Androutsos, Noranda (AU)

(21) Appl. No.: 17/474,088

(22) Filed: Sep. 14, 2021

(51) Int. Cl. F04F 1/10

(52) U.S. Cl. CPC F04F 1/10; G05B 15/02

(57) ABSTRACT

A pumping system for liquids, comprising of a direct air displacement pump, which does not require a liquid level sensor mounted inside the pump body. It includes a smart controller which is able to drive and estimate the pump status (full or empty) with sensors mounted above ground.

### FIELD OF THE INVENTION

The present invention relates to direct air displacement pumping systems for liquids.

### BACKGROUND OF THE INVENTION

Direct air displacement pumps are mainly submersible pumps for pollution recovery, dewatering and pumping liquids from wells, bores, sumps, ponds, pits and building foundations. References on how to build such a pump can be found in the book entitled, “Tools for mining—Techniques and processes for small scale mining”, by M. Priester, T. Hentschel and B. Benthin, which was published in 1993 and includes a description of this particular pump (section 4.1) based on C. H. Fritzsche's work entitled, “Landtechnik Weichenstephan” (circa 1960).

Section 4.1 of Priester et.al. states that “the air displacement pump as per C. H. Fritzsche, consists of a displacement chamber with two check valves:
“An intake check valve and a discharge check valve with an uptake on the delivery side of the pump. The intake and discharge are located at the bottom of the pump housing, where a stand pipe is serving as the outlet. A compressed airline, externally controlled by means of a three-way cock, is connected to the pump chamber. Water from the bore/sump flows through the intake check valve into the pump chamber. When the pump chamber is full, the three-way cock is turned to allow compressed air to flow into the chamber. The intake check valve closes and the discharge check valve starts to open. The compressed air drives the water out through the standpipe, outlet check valve and uptake pipe. After all the water has been discharged, the three-way cock is switched open, the air pressure drops, the outlet check valve closes, the intake check valve begins to open and water again flows into the pump chamber.”

The Existing Products on the Market and their Problems

In order to automate the pumping process different methods of control have been employed by different manufacturers. In all cases, a type of sensor (mechanical, electrical, supersonic, etc.) mounted inside the pump body provides the information that the pump is empty or full, so the air valve can change state (pressure-exhaust). This sensor requires maintenance after a certain period depending on the water quality (salinity, acidity, bacteria build up, etc) which is expensive and time consuming (the pump has to be removed from the bore). Let's take a quick look at some of the existing methods.

The float: In this case, a float can slide inside the (vertical) pump body and is connected to an air valve with means of levers, latches, etc. When the pump is empty, the float sits at the bottom end of the pump body and sets the air valve to exhaust mode. The pump starts filling with water. The float gradually comes up until it reaches the top end of the pump body and sets the air valve to pressure mode. Compressed air enters the pump and as a result, the pump starts discharging water until empty. The float gradually drops down until it returns to the bottom of the pump body. The air valve state changes to exhaust and the pump starts filling with water. The sliding float, the latching mechanism and the air valve pistons are all working under water. In clean water the servicing intervals are acceptable, but in harsh conditions (salty water, iron bacteria, leachate, grit) they are useless. If the bore is inclined (as in most landfill sites), the float becomes ineffective and the pump does not cycle.

The probes: In this case, three probes (ground probe, top probe, bottom probe) are mounted inside the pump body. These probes provide a signal (pump is full, pump is empty) to a controller usually mounted above ground. This controller changes the air valve state in order to let the pump fill (exhaust mode) or discharge the water from inside the pump body (pressure mode). As the probes are sensitive, a slight change to the water salinity can change the water conductivity and the pump will not function. If the water is contaminated and oil sits on the probes, they form a film of insulation and the pump will not function. The setup is complicated, as a cable is located downhole and has to be connected via a waterproof plug to the probes which are mounted in a high pressure area. A tiny leak is enough to short circuit the conductors and put the pump out of order. The electric signal required for the probes operation must be fed through intrinsic safe barriers if the intention is to use it in explosive environments (e.g. leachate wells).

The dual timer: In this case, the air valve state is switching based on a preset timer program (filling time, emptying time). This is an open loop system and has poor efficiency as it can lead to high compressed air consumption per unit of delivered water.

The tuning fork level switch: An electronic circuit continuously stimulates the tuning fork which is mounted inside the pump body, causing it to mechanically vibrate. When the prongs of the fork contact anything with substantial mass (water in our case), the resonant frequency of the fork decreases. The circuit detects this frequency change and indicates the presence of mass contacting the fork. This is an expensive solution as it uses advanced electronics. A cable has to be installed downhole and be connected via a waterproof plug to the tuning fork. The tunning fork can also be affected by iron bacteria build-up and must be fed through intrinsic safe barriers if it is to be used in explosive environments (e.g. leachate wells).

The floating level switch: A floating switch is mounted inside the pump body close to the top end. This switch opens/closes a contact when the pump fills. A controller usually mounted above ground detects the signal from the floating level switch and sets the air valve state to pressure mode. The pump starts discharging. As the pump emptying time is unknown it works on a timer basis. With this solution a cable has to be installed downhole and be connected via a waterproof plug to the floating level switch. The floating switch operation can be affected by high salinity water or iron bacteria built up. The electric signal required from the floating switch feedback must be fed through intrinsic safe barriers if it is to be used in explosive environments (e.g. leachate wells). If the bore is inclined (as in most landfill sites), the float becomes ineffective and the pump will not cycle.

As such, the desired object of the invention is to provide an alternate system of direct air displacement pump for liquids with a smart controller that overcomes, or at least minimises, the problems associated with the current systems.

### BRIEF DESCRIPTION OF THE INVENTION

With the present invention, there is no need to have any sort of liquid level sensors inside the pump body. All the critical components (sensors, smart controller, air valve, etc) are mounted above ground, making maintenance and servicing easy and at the same time, the pump vessel becomes more reliable as it contains less components that could fail.

The combination of this pump body design and the smart controller allow us to indirectly monitor the pump state (full or empty) by measuring the airline and discharge line pressures. The smart controller reads data from both pressure sensors (05, 13) and after calculations it changes the air valve (06) state to pressure or exhaust. The pump operation is not affected by any changes of the water salinity, can be used to pump contaminated liquids and can operate in inclined bores.

The smart controller can operate in two modes depending on the application requirements. The operation in each mode can be better understood by explaining the system setup first.

### BRIEF DESCRIPTION OF THE DRAWINGS

FIG. 1 is a diagrammatic representation of the direct air displacement pump for liquids with smart controller according to the first aspect.

FIG. 2 is a diagrammatic representation of the direct air displacement pump for liquids with smart controller according to the second aspect.

FIG. 3 is a diagrammatic representation of the direct air displacement pump for liquids with smart controller according to the third aspect.

FIG. 4 is a graph representation of the pressure change related to the time.

FIG. 5 is a graph representation of the pressure change related to the time.

### DESCRIPTION OF THE EMBODIMENTS

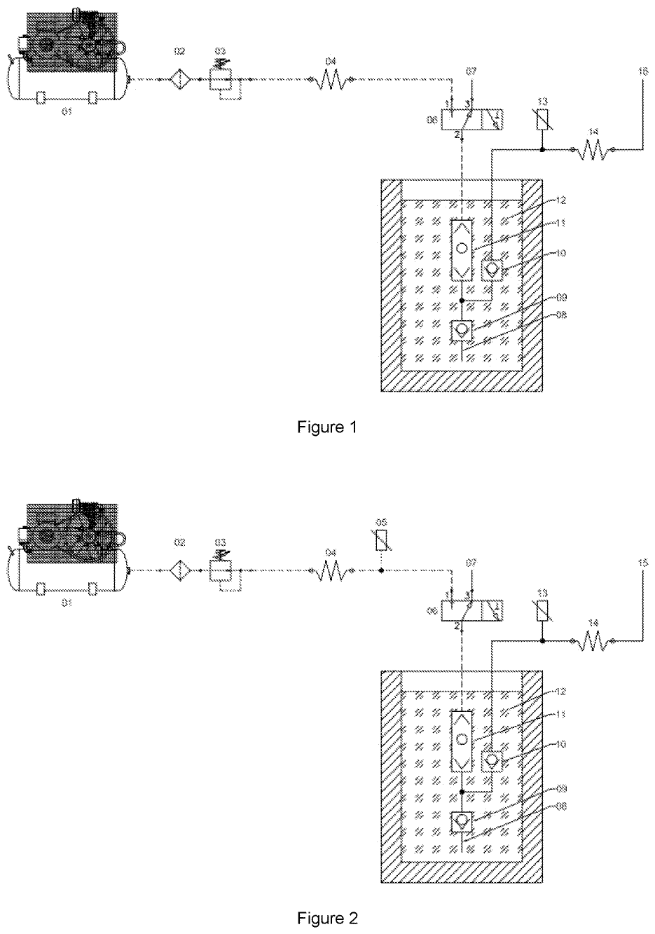

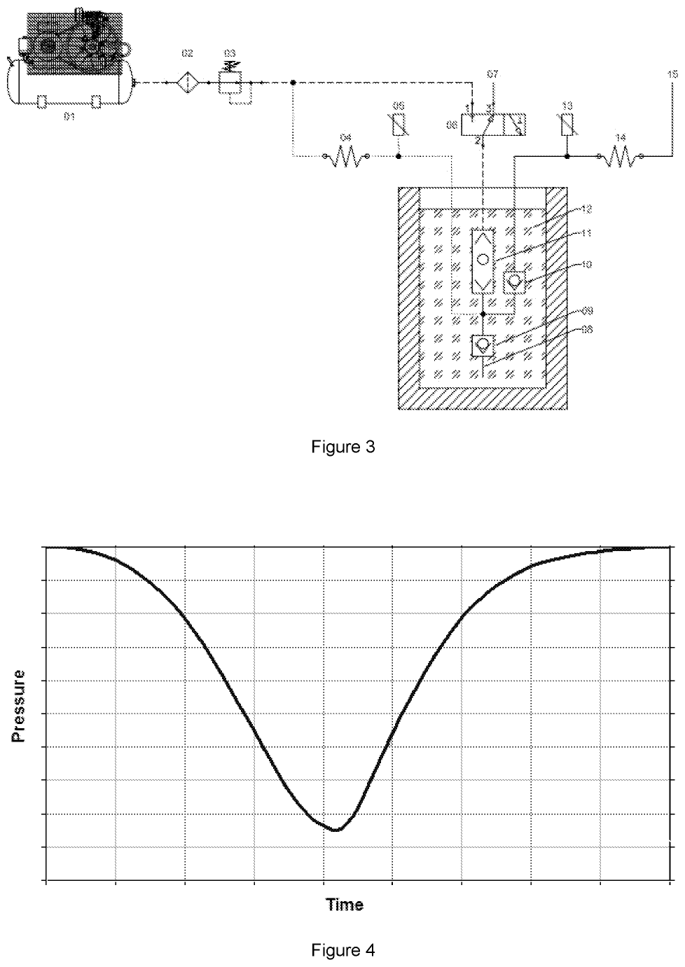

In FIG. 1, FIG. 2 and FIG. 3 one can identify the following:
01: Air compressor
02: Air filter
03: Pressure regulator
04: Line restriction
05: Pressure sensor
06: Air valve
07: Exhaust
08: Liquid intake
09: Liquid intake check valve
10: Discharge line check valve
11: Pump body
12: Liquid to be pumped
13: Pressure sensor
14: Line restriction
15: Liquid discharge

### DETAILED DESCRIPTION OF THE DRAWINGS

According to a first aspect, as shown in FIG. 1, an air compressor (01) provides compressed air to the network (dashed line). The compressed air passes through a filter element (02) and a pressure regulator (03). The regulated air pressure has to be higher than the discharge line head measured from the bottom end of the pump.

The compressed air passes through a line restriction or orifice (04) and then continues to a larger sized tube. The compressed air is connected to port No1 of a 3-way, 2-position air valve (06). Port No2 of the air valve (06) is connected at the top port of the pump body (11).

The pump body (11) is submersed in liquid (12) and has two ports, the top port and the bottom port. Inside the pump body there is a floating ball which acts as a check valve at the top port when the pump is full of liquid and as a check valve at the bottom port when the pump is empty. The bottom port of the pump serves as both liquid intake and discharge.

When the pump is in exhaust mode (the top port is in atmospheric pressure) the pump body is filled with liquid through the check valve (09); check valve (10) is closed as a result of the head pressure at the discharge line.

When the pump is in pressure mode (the top port is being fed with compressed air) the pump body discharges liquid through the check valve (10); check valve (09) is closed as a result of high pressure at the discharge line.

The liquid in the discharge line (continuous line) is fed to the customer network (or free flow) through a line restriction or orifice (14). The discharge line pressure just before the restriction (14) is being monitored continuously by the pressure sensor (13).

According to a second aspect, as shown in FIG. 2, an air compressor (01) provides compressed air to the network (dashed line). The compressed air passes through a filter element (02) and a pressure regulator (03). The regulated air pressure has to be higher than the discharge line head measured from the bottom end of the pump.

The compressed air passes through a line restriction or orifice (04) and then continues to a larger sized tube. The pressure sensor (05) continuously measures the airline pressure at that point. The compressed air is connected to port No1 of a 3-way, 2-position air valve (06). Port No2 of the air valve (06) is connected at the top port of the pump body (11).

The pump body (11) is submersed in liquid (12) and has two ports, the top port and the bottom port. Inside the pump body there is a floating ball which acts as a check valve at the top port when the pump is full of liquid and as a check valve at the bottom port when the pump is empty. The bottom port of the pump serves as both liquid intake and discharge.

When the pump is in exhaust mode (the top port is in atmospheric pressure) the pump body is filled with liquid through the check valve (09); check valve (10) is closed as a result of the head pressure at the discharge line.

When the pump is in pressure mode (the top port is being fed with compressed air) the pump body discharges liquid through the check valve (10); check valve (09) is closed as a result of high pressure at the discharge line.

The liquid in the discharge line (continuous line) is fed to the customer network (or free flow) through a line restriction or orifice (14). The discharge line pressure just before the restriction (14) is being monitored continuously by the pressure sensor (13).

According to a third aspect, as shown in FIG. 3, an air compressor (01) provides compressed air to the network (dashed line). The compressed air passes through a filter element (02) and a pressure regulator (03). The regulated air pressure has to be higher than the discharge line head measured from the bottom end of the pump.

One branch of the compressed air line (dotted line) passes through a line restriction or orifice (04). The pressure sensor (05) continuously measures the airline pressure at that point. This compressed air line is connected to the bottom port of the pump body (11).

The second branch of the compressed air line (dashed line) is connected to the port No1 of a 3-way, 2-position air valve (06). The port No2 of the air valve (06) is connected to the top port of the pump body (11).

The pump body (11) is submersed in liquid (12) and has two ports, the top port and the bottom port. Inside the pump body there is a floating ball which acts as a check valve at the top port when the pump is full of liquid and as a check valve at the bottom port when the pump is empty. The bottom port of the pump serves as both liquid intake and discharge.

When the pump is in exhaust mode (the top port is in atmospheric pressure) the pump body is filled with liquid through the check valve (09); check valve (10) is closed as a result of the head pressure at the discharge line.

When the pump is in pressure mode (the top port is being fed with compressed air) the pump body discharges liquid through the check valve (10); check valve (09) is closed as a result of high pressure at the discharge line.

The liquid in the discharge line (continuous line) is fed to the customer network (or free flow) through a line restriction or orifice (14). The discharge line pressure just before the restriction (14) is being monitored continuously by the pressure sensor (13).

### DETAILED DESCRIPTION OF THE INVENTION

According to the first aspect, (FIG. 1), assuming that the pump body is submersed in the liquid, the smart controller is turned off and the air valve is in exhaust mode. As a result, the pump body (11) is full of liquid (12) which has entered through intake (08) and check valve (09).

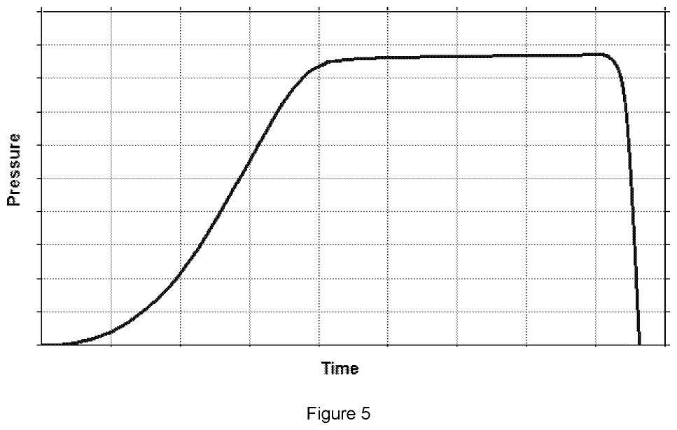

We turn on the smart controller. The smart controller gets a reading of the pressure sensor (13) and then sends a command to the air valve (06). The air valve (06) state goes to pressure mode and a slug of air rushes downhole (dashed line). As a result of the restriction (04), it takes some time to the indication of the pressure sensor (13) to increase, as indicated in FIG. 5. The amount of time required to increase the pressure sensor (13) indication at a certain value is indicative of the percentage of liquid that was in the pump vessel before starting the pump discharging process. This amount of time is compared to the average of the preceding attempts. If it is less, this means that the pump vessel happened to have more liquid in it. If it is greater, this means that the pump vessel happened to have less liquid in it. The next pump filling time is extended or reduced accordingly. The conditions that may impact on the pump's filling time are:

change to the liquid level (12), blockage to the foot valve (09), bacteria build up in the pump inner body (11), change in the liquid viscosity, etc. As the pump starts discharging liquid, the pressure sensor (13) indication rises as a result of the restriction (14), even with a free flow. As the pump vessel empties, the floating ball drops down until it reaches the bottom end and plugs the pump bottom port. At this time, we notice a drop at the pressure sensor (13) indication (pump is empty). The controller sends a command to the air valve (06) and changes its state to exhaust mode (pump is filling). The controller waits for x amount of seconds (as calculated above) to fill the pump and then the same process is repeated.

The first inventive step is the way the smart controller of the first aspect (FIG. 1) can estimate when the pump is full, as there is no sensor mounted inside the pump body. After the air valve state changes from exhaust mode to pressure mode, it takes a certain amount of time for both the airline going downhole (dashed line) and the pump body (11) to fill with compressed air. This amount of time is short if the pump body is full of liquid and long if the pump body is empty. The smart controller timer starts counting straight after the air valve (06) state changes from exhaust to pressure mode. But the endpoint of this timer is not clearly identified. The line restriction (14) is there to help define this timer endpoint. As a slug of compressed air starts flowing from the air valve through the airline towards the pump body, it takes some time to the pressure sensor (13) indication to increase. With the passage of time, the pump body inner pressure gradually increases and the indication of the pressure sensor (13) increases, as shown in FIG. 5. The timer endpoint can be defined as the point where the pressure sensor (13) indication raises to a certain value.

According to the second aspect, (FIG. 2), assuming that the pump body is submersed in the liquid, the smart controller is turned off and the air valve is in exhaust mode. As a result, the pump body (11) is full of liquid (12) which has entered through intake (08) and check valve (09).

We turn on the smart controller. The smart controller gets a reading of the pressure sensor (05) and then sends a command to the air valve (06). The air valve (06) state goes to pressure mode and a slug of air rushes downhole (dashed line). As a result of the restriction (04), the indication of the pressure sensor (05) drops and then increases, as indicated in FIG. 4. The amount of time required to drop the pressure and then increase at a certain value is indicative of the percentage of liquid that was in the pump vessel before starting the pump discharging process. This amount of time is compared to the average of the preceding attempts. If it is less, this means that the pump vessel happened to have more liquid in it. If it is greater, this means that the pump vessel happened to have less liquid in it. The next pump filling time is extended or reduced accordingly. The conditions that may impact on the pump's filling time are: change to the liquid level (12), blockage to the foot valve (09), bacteria build up in the pump inner body (11), change in the liquid viscosity, etc. As the pump starts discharging liquid, the pressure sensor (13) indication rises as a result of the restriction (14), even with a free flow. As the pump vessel empties, the floating ball drops down until it reaches the bottom end and plugs the pump bottom port. At this time, we notice a drop at the pressure sensor (13) indication (pump is empty). The controller sends a command to the air valve (06) and changes its state to exhaust mode (pump is filling). The controller waits for x amount of seconds (as calculated above) to fill the pump and then the same process is repeated.

The second inventive step is the way the smart controller of the second aspect (FIG. 2) can estimate when the pump is full, as there is no sensor mounted inside the pump body. After the air valve state changes from exhaust mode to pressure mode, it takes a certain amount of time for both the airline going downhole (dashed line) and the pump body (11) to fill with compressed air. This amount of time is short if the pump body is full of liquid and long if the pump body is empty. The smart controller timer starts counting straight after the air valve (06) state changes from exhaust to pressure mode. But the endpoint of this timer is not clearly identified. The line restriction (04) is there to help define this timer endpoint. As a slug of compressed air starts flowing from the air valve through the airline towards the pump body, the indication of the pressure sensor (05) drops as the air line filling rate is small due to the line line restriction (04) and the compressed air temporarily expands. With the passage of time, the pump body inner pressure gradually increases and the indication of the pressure sensor (05) increases, as shown in FIG. 4. The timer endpoint can be defined as the point where the pressure sensor (05) indication raises to a certain value.

According to the third aspect, (FIG. 3), assuming that the pump body is submersed in the liquid, the smart controller is turned off and the air valve is in exhaust mode. As a result, the pump body (11) is full of liquid (12) which has entered through the intake (08) and the check valve (09).

Compressed air is trying to go downhole (dotted line), but as the pump body is full of liquid and the floating ball has reached the top end, the top port has been blocked and the pressure sensor (05) indicates the airline pressure as set up by the pressure regulator (03).

We turn on the smart controller. The smart controller sends a command to the air valve (06). The air valve (06) state goes to pressure mode and compressed air rushes downhole (dashed line). The pump starts discharging liquid and the pressure sensor (13) indication rises as a result of the restriction (14), even with a free flow. As the pump vessel empties, the floating ball drops down until it reaches the bottom end and plugs the pump bottom port. At this time, we notice a drop at the pressure sensor (13) indication (pump is empty). The controller sends a command to the air valve (06) and changes its state to exhaust mode (pump is filling).

During filling, a tiny amount of compressed air is flowing through the line restriction (04) (dotted line), enters the pump body (11) from the bottom port, exits the pump body (11) from the top port, flows towards the air valve (06) (dashed line) and finally escapes to the atmosphere through the exhaust (07). The amount of pressure drawn in the dotted airline branch is proportional to the level of liquid build inside the pump body (11). However, as the floating ball inside the pump body (11) reaches the top end, it blocks the top port and the pressure sensor (05) indication continues to increase until it reaches the pressure regulator (03) set pressure.

As a result of this pressure increase, the smart controller senses that the pump body is full of liquid and sends a command to the air valve (06) to change to pressure mode and then the same process is repeated.

The third inventive step is the way the dotted airline (known also as a bubbler line) informs the smart controller of the liquid level inside the pump body. This bubbler line is mounted outside the pump body and provides information on the liquid level inside the pump body. In conjuction with the floating ball inside the pump body (11), when the pump gets full and the floating ball reaches the top end of the pump body it blocks the top port. The pressure indication of the pressure sensor (05) is no more proportional to the liquid level inside the pump body (11), but ramps up until reaches the maximum airline pressure as set up by the pressure regulator (03). This ramp up of the pressure indication of the pressure sensor (05) provides enough information to the smart controller to sense that the pump body is full and it is time to change the air valve (06) to pressure state.

The fourth inventive step is the way the smart controller of all the above aspects can estimate when the pump is empty. Let's assume that the air valve (06) is in exhaust mode and the pump body (11) is filling with liquid. The indication of the pressure sensor (13) equals the static head pressure after that point (which can be the atmospheric pressure if we have free flow). As the air valve (06) state changes to pressure mode the pump starts discharging liquid through the discharge line (solid line). If we have a free flow, the indication of the pressure sensor (13) increases as a result of the line restriction (14) as shown in FIG. 5. If a tank is filling, the indication of the pressure sensor (13) increases as a result of overcoming the discharge line friction. If there is a valve closed at the discharge line, the indication of the pressure sensor (13) increases as a result of the applied air pressure inside the pump body. The smart controller waits until the pressure sensor (13) indication drops to a certain percentage (e.g. 10%) above the initial measured pressure (the pressure just before the air valve state changed from exhaust to pressure mode).

1. A direct air displacement pumping system for liquids comprising of a direct air displacement pump, a smart controller, a line restriction connected at the compressed air line and a line restriction with a pressure sensor or a pressure switch connected at the discharge line.

2. A direct air displacement pumping system for liquids comprising of a direct air displacement pump, a smart controller, a line restriction with a pressure sensor or a pressure switch connected at the compressed air line and a line restriction with a pressure sensor or a pressure switch connected at the discharge line.

3. A direct air displacement pumping system for liquids comprising of a direct air displacement pump, a smart controller, a line restriction with a pressure sensor or a pressure switch connected at the bubbler line and a line restriction with a pressure sensor or a pressure switch connected at the discharge line.

4. A direct air displacement pump as claimed in claim 1, claim 2 and claim 3, comprising of a cylindrical pump body, having a top port and a bottom port; a floating ball mounted inside the pump body which acts as a bottom port check valve when the pump is empty and as a top port check valve when the pump is full of liquid; a check valve which acts as a liquid intake only from the liquid container towards the pump body and, finally, another check valve which acts as a liquid discharge only from the pump body towards the discharge line.

5. A smart controller as claimed in claim 1, comprising of a computer, or a PLC (programmable logic controller), or a smart relay, or an electric circuit, or an electronic circuit, or a mechanical actuating system, or a combination thereof, connected with a pressure sensor or pressure switch mounted at the discharge line of the pumping system, also connected with an air actuated or solenoid actuated or mechanically actuated air valve which controls the pump body state (pressure or exhaust).

6. A smart controller as claimed in claim 2 and claim 3, comprising of a computer, or a PLC (programmable logic controller), or a smart relay, or an electric circuit, or an electronic circuit, or a mechanical actuating system, or a combination thereof, connected with a pressure sensor or pressure switch mounted at the airline of the pumping system, also connected with a pressure sensor or pressure switch mounted at the discharge line of the pumping system, also connected with an air actuated or solenoid actuated or mechanically actuated air valve which controls the pump body state (pressure or exhaust).

5. A direct air displacement pump as claimed in claim 4, comprising of aluminium, or copper, or brass, or stainless steel, or plastic, or polyethylene, or polypropylene, or urethane, or glass, or plexiglass, or a combination thereof.

6. A direct air displacement pump as claimed in claim 4, suitable for liquids.

7. A set of multiple direct air displacement pumps as claimed in claim 1, claim 2 and claim 3, combined with a smart controller as claimed in claim 5.
